(19) United States
(12) Patent Application Publication
(10) Pub. No.: US 2015/0309690 A1
(43) Pub. Date: Oct. 29, 2015

(54) METHOD AND SYSTEM FOR SEARCHING INFORMATION RECORDS

(71) Applicant: Alibaba Group Holding Limited, George Town (KY)

(72) Inventor: Qiqi Wang, Hangzhou (CN)

(21) Appl. No.: 14/693,732

(22) Filed: Apr. 22, 2015

(30) Foreign Application Priority Data
Apr. 24, 2014 (CN) 201410169138.4

(51) Int. Cl. G06F 3/0488; G06F 17/30; G06F 3/041

(52) U.S. Cl. CPC G06F 3/0488; G06F 3/041; G06F 17/30979

(57) ABSTRACT

Providing searching information records includes detecting a touch action input by a user via a touchscreen, determining whether the touch action corresponds to a predefined search switching action, in the event that the touch action corresponds to the predefined search switching action, switching an application program currently displayed on the touchscreen to a search mode corresponding to the search switching action, displaying on the touchscreen an information record index relating to the search mode for the application program, determining whether a touchscreen display zone corresponding to an index node in the information record index displayed by the touchscreen has detected an information search action input by the user, and displaying an information record or a next-level index corresponding to the index node in the event that the information search action input by the user has been detected.

### CROSS REFERENCE TO OTHER APPLICATIONS

This application claims priority to People's Republic of China Patent Application No. 201410169138.4 entitled A METHOD AND A DEVICE FOR SEARCHING INFORMATION RECORDS ON A TOUCHSCREEN TERMINAL, filed Apr. 24, 2014 which is incorporated herein by reference for all purposes.

### FIELD OF THE INVENTION

The present application relates to a method and system for searching information records.

### BACKGROUND OF THE INVENTION

A touchscreen is a sensing-type liquid crystal display device that can receive touch-sensitive signal input. The touchscreen includes a touch-detecting component and a touchscreen controller. The touch-detecting component is installed on the front of a display screen and detects a user touch position. After receiving a touch action, the touch-detecting component transmits touch action information to the touchscreen controller. The touchscreen controller receives the touch action information from the touch-detecting component, converts the touch action information to touch point coordinates, and transmits the touch point coordinates to a central processing unit (CPU). The touchscreen controller also receives and performs commands issued by the CPU. “Touchscreen terminal” refers to a computer terminal that includes a touchscreen. Examples of touchscreen terminals include smartphones, tablets, laptop computers, desktop computers, etc. As touchscreen technology develops, touchscreen terminal applications have become more widespread. Touchscreen terminals are becoming an indispensable part of everyday life because not only do the touchscreen terminals make communications more convenient, they also help increase work efficiency. Additionally, the touchscreen terminals store and display information.

Currently, when a user searches for one or more records among information records stored in a touchscreen terminal, a small portion of information records is displayed based on target records directly searched for in all information searched by application programs and keywords entered into a search box. Subsequently, the target records are searched for in the small portion of information records.

The above conventional process for searching target records on a touchscreen takes time and effort. Typically, when an application program is used for a long time or when a large volume of data exists, the quantity of information records stored by the application program is very large. A user usually has two ways to acquire one or more target records from among information records stored by the application program. In a first way, the user directly searches for target records among all the information records stored by the application program. Such a process requires repeated sliding of the information records displayed on the touchscreen or searching for target records in the displayed information records through continual page-turning. The first way wastes a great deal of time and effort. In a second way, the user enters keywords into a search box and screens and searches for target records. In the second way, the user cannot easily locate precise keywords from a large quantity of information records. Finding the right target records with an inaccurate keyword can be very difficult.

### BRIEF DESCRIPTION OF THE DRAWINGS

Various embodiments of the invention are disclosed in the following detailed description and the accompanying drawings.

FIGS. 1A and 1B are flowcharts of an embodiment of a process for searching information records.

FIG. 2 is a search mode diagram of an embodiment of a process for searching information records.

FIG. 3 is a next-level index diagram of an embodiment of a process for searching information records.

FIG. 4 is an information records diagram of an embodiment of a process for searching information records.

FIG. 5A is a scrolling display diagram of an embodiment of a process for searching information records.

FIG. 5B is diagrams of an example of a time search of information records.

FIG. 5C is diagrams of examples of location searches of information records.

FIG. 6 is a diagram of an embodiment of a device for searching information records.

FIG. 7 is a functional diagram illustrating an embodiment of a programmed computer system for searching information records.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

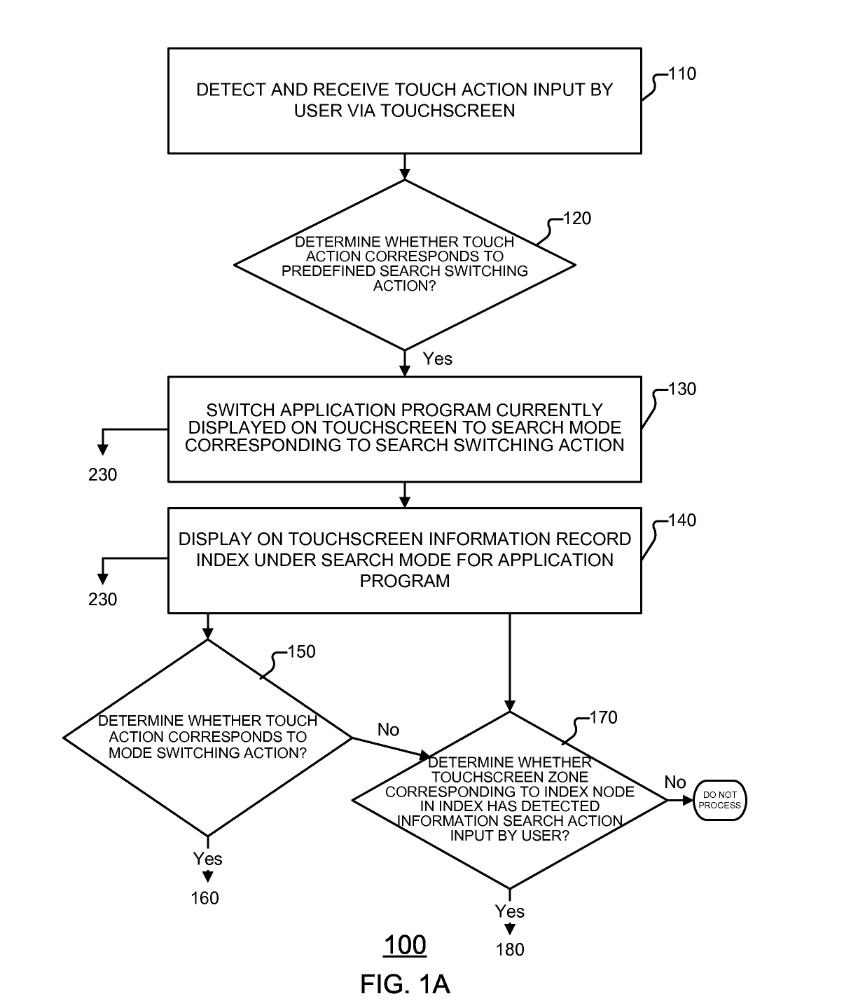

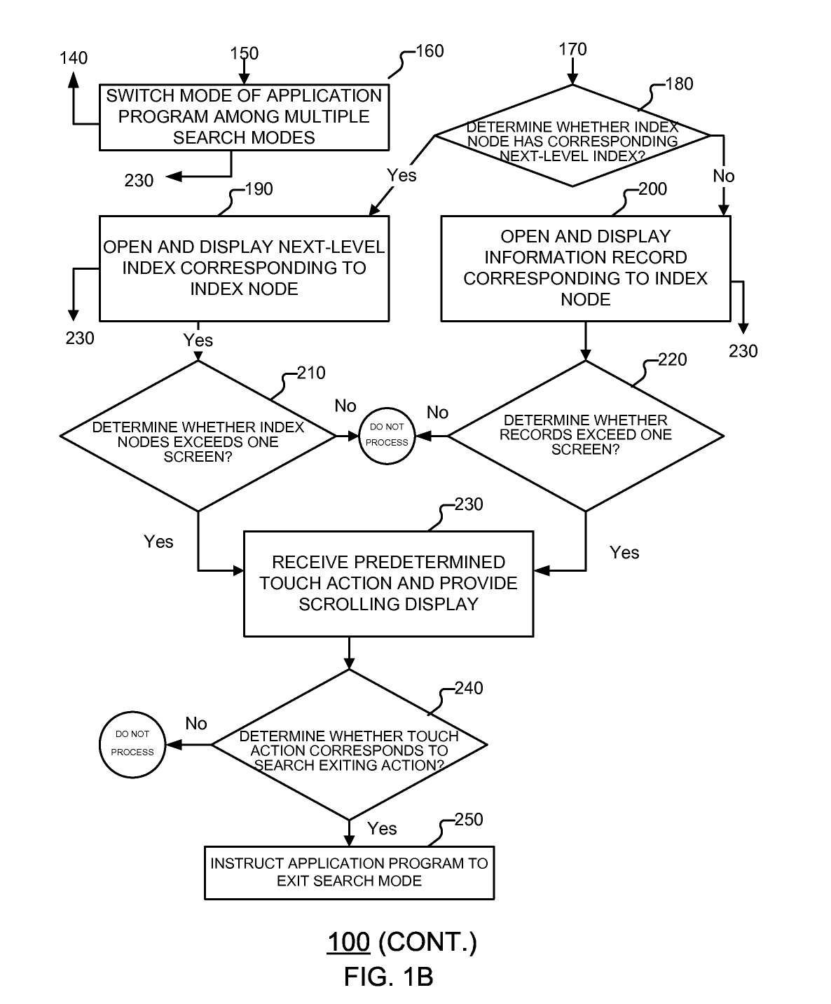

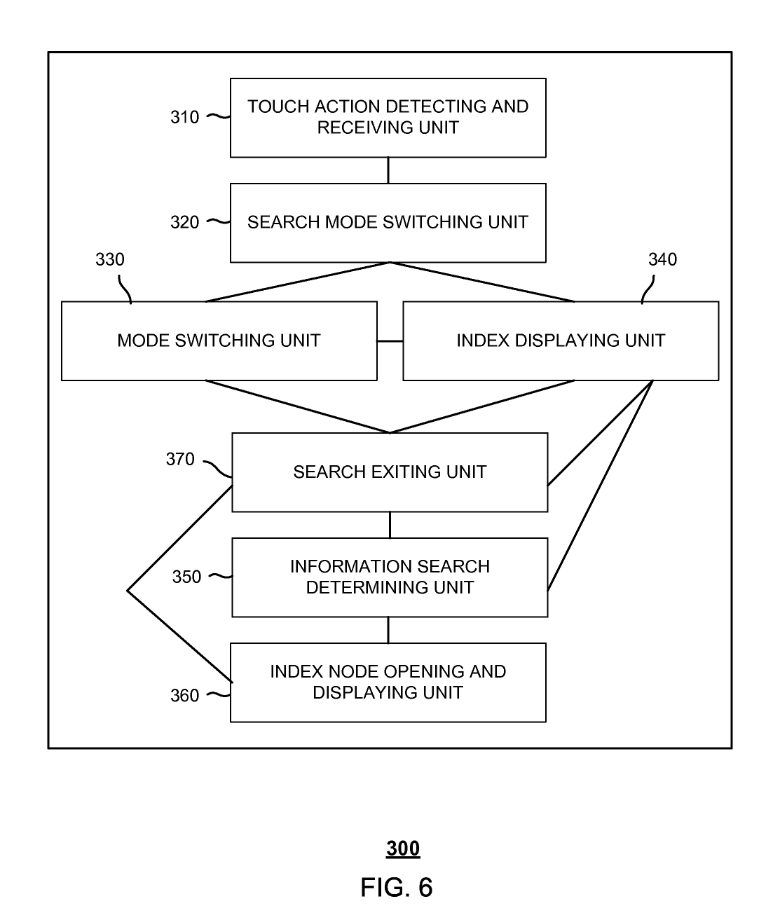

FIGS. 1A and 1B are flowcharts of an embodiment of a process for searching information records. In some embodiments, the process 100 is implemented by a touchscreen terminal 300 of FIG. 6 and comprises:

In 110, the touchscreen terminal detects and receives a touch action input by a user via a touchscreen.

In some embodiments, the touchscreen includes a touch-detecting component and a touchscreen controller. The touch-detecting component can be a capacitive or resistive sensing device located on a front of a display screen configured to detect a user's touch position (e.g., the touch position of a finger or a stylus). After receiving touch information, the touch-detecting component transmits the touch information to the touchscreen controller. Some of the roles of the touchscreen controller include receiving touch information from the touch-detecting component, converting the touch information to touch point coordinates, and transmitting the touch point coordinates to a central processing unit (CPU). In some embodiments, the touchscreen controller also receives and executes commands issued by the CPU.

After the touchscreen detects a touch action issued by the user, the touchscreen receives information pertaining to the touch action. Then the touchscreen transmits the touch information represented by the touch action to the touchscreen terminal processor, which can be the same as the CPU or a separate processor used to process the touch action information. The touchscreen terminal processor processes the touch information and identifies the touch action corresponding to the touch information. The touchscreen terminal processor compares the touch action with preset search switching actions of the application program displayed on the current touchscreen and determines the touch action.

In some embodiments, the touch action is an action generated by an interaction via a finger or stylus with the touchscreen. The interaction includes the user's touching of the screen and the device's sensing of the touch. In addition to the above touch action, other sensor-detectible objects are able to interact with the touchscreen or interactions other than touching or sensing are possible. In some embodiments, the touchscreen terminal corresponds with a touchscreen mobile telephone, a touchscreen tablet, or the like.

In 120, the touchscreen terminal determines whether the touch action corresponds to a predefined search switching action.

Based on operation 110, in the event that the touchscreen detects and receives the touch action issued by the user, the touchscreen terminal determines whether the touch action corresponds to a predefined search switching action. If the touch action corresponds to a search switching action preset for an application program, then the touch action issued by the user is determined to correspond to the search switching action.

In some embodiments, the search switching action preset for the application program includes a time search switching action, a contact search switching action, a location search switching action, or any combination thereof, as well as a default search mode.

In some embodiments, the default search switching action preset for the application program is a two-finger right-sliding touch action. In some embodiments, the time search switching action corresponds to a one-finger touch action in which a “T” is drawn on the touchscreen, the contact search switching action corresponds to a one-finger touch action in which a “C” is drawn on the touchscreen, and the location search switching action corresponds to a one-finger touch action in which an “L” is drawn on the touchscreen.

Please note that the search switching action preset for the application program can include one or more search switching actions other than the above search switching actions. For example, other letters, characters, or gesture patterns can be used. In addition, the touch actions corresponding to the search switching actions can be touch actions other than the above touch actions such as, for example, blowing, shaking, or other actions.

In 130, in the event that the touch action corresponds to a search switching action, the touchscreen terminal switches the application program currently displayed on the touchscreen to a search mode corresponding to the search switching action based on the search switching action.

In some embodiments, in a one-to-one correspondence with the search switching actions described in the above operation 120, the search modes preset for the application program include a time search mode, a contact search mode, a location search mode, or any combination thereof, as well as a default search mode.

In the event that the search modes preset for the application program include two or more of the three modes (i.e., two or more of time search mode, contact search mode, or location search mode), then the default search mode is any one of the three modes. In the event that the search modes preset for the application program include one of the three modes (time search mode, contact search mode, and location search mode), then the search mode corresponds to the default search mode for the application program.

In the event that the touchscreen terminal detects and receives the default search switching action input by the user via the touchscreen, the application program currently displayed on the touchscreen is switched to the default search mode.

In the event that the touchscreen terminal detects and receives the time search switching action input by the user via the touchscreen, the application program currently displayed on the touchscreen is switched to the time search mode.

In the event that the touchscreen terminal detects and receives the contact search switching action input by the user via the touchscreen, the application program currently displayed on the touchscreen is switched to the contact search mode.

In the event that the touchscreen terminal detects and receives the location search switching action entered by the user via the touchscreen, the application program currently displayed on the touchscreen is switched to the location search mode.

Please note that a correspondence with the search switching actions described in the above operation 120 exists. The search modes preset for the application program can also include search modes other than the time search mode, contact search mode, and location search mode such as, for example, image search mode, text search mode, or others.

In 140, the touchscreen terminal displays on the touchscreen an information record index under the search mode for the application program.

In a one-to-one correspondence to the search switching actions and above search modes, the information record index for the application program under the time search mode corresponds to a time index, the information record index for the application program under the contact search mode corresponds to a contact index, and the information record index for the application program under the location search mode corresponds to a location index. In other words, the time index relates to the time search mode, the contact index relates to the contact search mode, and the location index relates to the location search mode.

In the event that the touchscreen terminal detects and receives a time search switching action input by the user via the touchscreen, and the application program currently displayed on the touchscreen is switched to the time search mode, the time index for the application program under the time search mode is displayed on the screen.

In the event that the touchscreen terminal detects and receives a contact search switching action input by the user via the touchscreen, and the application program currently displayed on the touchscreen is switched to the contact search mode, the contact index for the application program under the contact mode is displayed on the screen.

In the event that the touchscreen terminal detects and receives a location search switching action input by the user via the touchscreen, and the application program currently displayed on the touchscreen is switched to the location search mode, the location index for the application program under the location search mode is displayed on the screen.

The time index includes time index nodes, and the time index nodes are arranged in chronological sequence. The contact index includes contact index nodes, and the contact index nodes are arranged in an alphabetic order of surname. The location index includes location index nodes, and the location index nodes are arranged in order of location information name. An index is composed of a listing of index nodes.

In the event that the index nodes corresponding to the index are relatively numerous and the displayed index nodes cover the entire display area of the touchscreen when the index nodes are displayed on the touchscreen, a determination is to be made regarding the index nodes as to whether content exists outside of the touchscreen display area. In the event that content exists outside of the touchscreen display area regarding the index nodes, proceed to operation 230.

The following is a description of indexes shown on the touchscreen for the above three search modes (the time search mode, the contact search mode, and the location search mode).

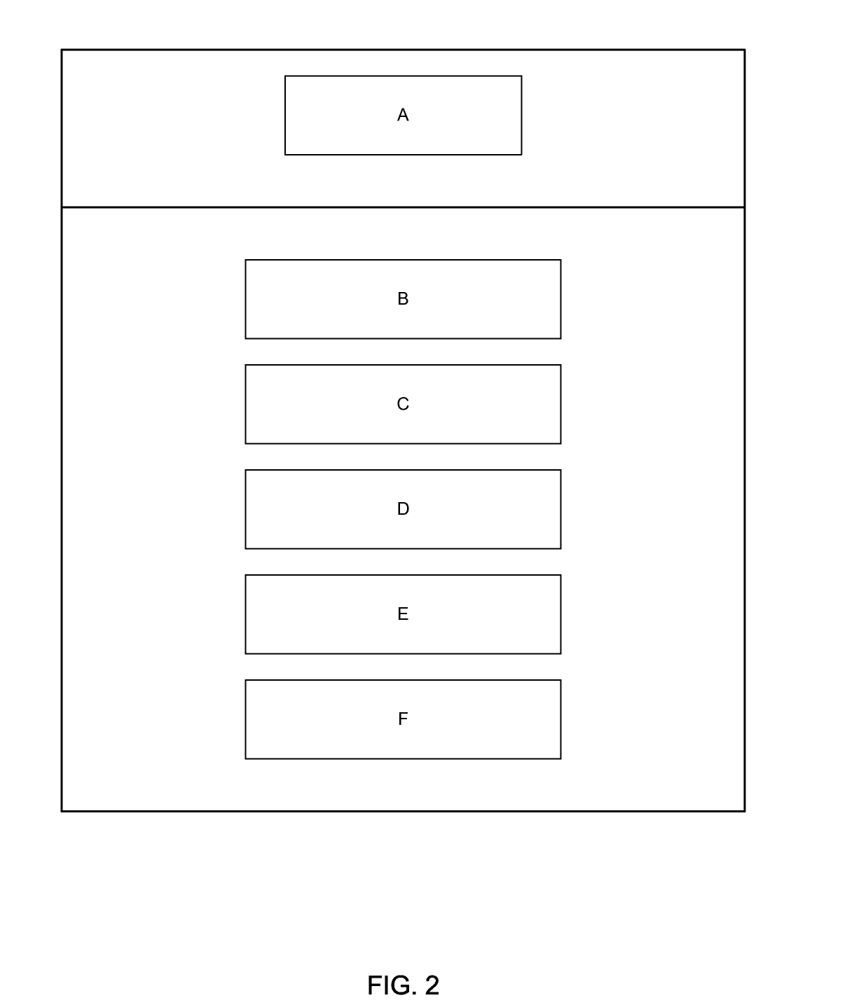

FIG. 2 is a search mode diagram of an embodiment of a process for searching information records. Areas A, B, C, D, E, and F are displayed on a touchscreen terminal.

The area corresponding to A displays the type of search mode, i.e., time search mode, contact search mode, or location search mode. The areas corresponding to B, C, D, E and F display an index of the information records for the application program corresponding to the search mode.

Regarding the time search mode, the area corresponding to A displays the time search mode. The areas corresponding to B, C, D, E and F display time index nodes in a time index of the information records under the time search mode. The time index nodes include time points. For example, areas B, C, D, E and F correspond to time points 11:00, 12:00, 13:00, 14:00, and 15:00, respectively.

Regarding the contact search mode, the area corresponding to A displays the contact search mode. The areas corresponding to B, C, D, E and F display contact index nodes in a contact index of the information records under the contact search mode. The contact index nodes include contacts.

Regarding the location search mode, the area corresponding to A displays the location search mode. The areas corresponding to B, C, D, E and F display location index nodes in a location index of the information records under the location search mode. The location index nodes include location information.

The above indices and index nodes are merely examples illustrating the operation. The indices and index nodes can be implemented different from the implementations described above.

In 150, the touchscreen terminal determines whether the touch action corresponds to a mode switching action.

During the process 100 above, after the application program has been switched to a search mode and the index under the corresponding search mode has been displayed on the touchscreen, if the touch screen detects and receives a user issued touch action at this point, the touchscreen terminal determines whether the touch action is a mode switching action.

In the event that the application program enters a search mode, no target record is found under the search mode, and at this point if the user wishes to continue the search process through another search mode, a fast-key search action (i.e., a mode switching action) is provided to facilitate rapid switching to another search mode by the user. In some embodiments, the mode switching action includes a single-finger sliding touch action, such as a single-finger left-sliding touch action or a single-finger right-sliding touch action. Other mode switching actions can be used.

In some embodiments, the mode switching action described by operation 150 occurs where multiple search modes are preset for the application program. In the event that only one search mode preset for the application program exists, no response occurs in the event that the touchscreen detects the mode switching action.

In 160, the touchscreen terminal switches the mode of the application program among multiple search modes based on the mode switching action.

In the above operation 150, when responding to the mode switching action, the touchscreen terminal first switches based on the mode switching action to the corresponding search mode and proceeds to operation 140. Based on operation 140, the information record index for the application program under the search mode is displayed on the touchscreen.

As shown in FIG. 2, the search mode displayed in area A is changed based on the search switching action. Moreover, the index nodes corresponding to the information record index under the search mode that are displayed in the areas corresponding to B, C, D, E, and F are changed accordingly. For example, area A indicates that the search mode corresponds to a location search mode, and areas B, C, D, E, and F correspond to location 1, location 2, location 3, location 4, and location 5, respectively.

Referring back to FIGS. 1A and 1B, in 170, the touchscreen terminal determines whether a touchscreen display zone corresponding to an index node in the index displayed by the touchscreen has detected an information search action input by the user.

Based on the above operation 140, after the information record index for the application program under the search mode is displayed on the touchscreen, the touchscreen detects and receives the information search action input by the user and searches for target records based on the information search action input by the user.

In some embodiments, the information search action includes an index search action and a search start action.

In the event that the touchscreen detects and receives a user-input touch action as an index search action, operation 180 is performed.

In the event that the touchscreen detects and receives a user-input touch action as a search start action, operation 200 is performed.

The index search action corresponds to a control action for index nodes in the index displayed on the touchscreen. The search start action corresponds to a touch action which is likewise for index nodes in the index displayed on the touchscreen, but which is distinct from the index search action.

In some embodiments, the index search action corresponds to a touch action including a single tap on the touch screen zone corresponding to the index node. The search start action corresponds to a touch action including a double tap on the touch screen zone corresponding to the index node.

In some embodiments, there are multiple levels of indices. For example, a first level index includes a second level index. In other words, an index node of the first level index relates to a second level index.

In 180, the touchscreen terminal determines whether the index node has a corresponding next-level index.

In the event that the touchscreen detects and receives a user-input touch action as an index search action, the touchscreen terminal further determines whether the index node has a next-level index. In the event that the index node has a next-level index, operation 190 is performed; otherwise, operation 200 is performed.

A determination of whether the index node has a next-level index is performed because in the event that the information record corresponding to the current index node includes very little content, e.g., only one information record, the establishment of a next-level index for this index node would not offer any additional information and thus would have little meaning Thus, establishing a next-level index for this index node is not needed. In other words, this index node would not have a next-level index.

In 190, the touchscreen terminal opens and displays the next-level index corresponding to the index node.

Based on above operation 180, in the event that the index node has a next-level index and a user-input touch action is received as an index search action, the touchscreen terminal opens and displays the next-level index corresponding to the index node.

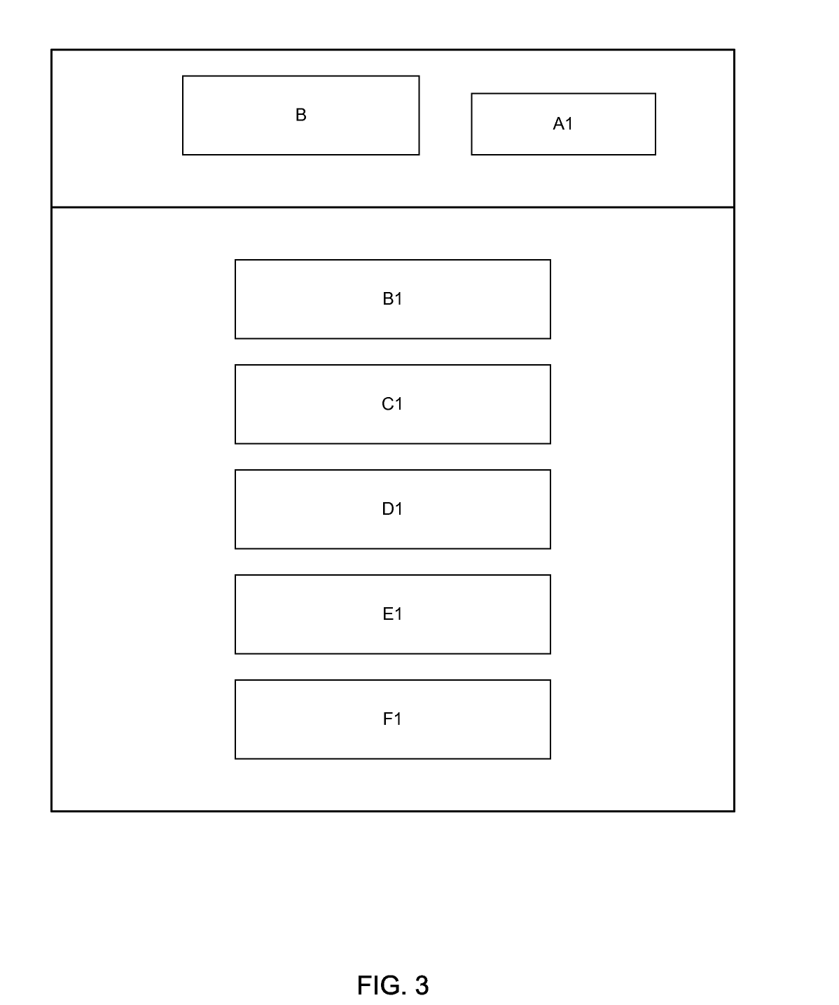

FIG. 3 is a next-level index diagram of an embodiment of a process for searching information records.

In some embodiments, assume that the touchscreen display zone corresponding to the index node displayed by area B detects and receives an index search action. The touchscreen terminal then opens and displays the next-level index, as shown in FIG. 3. The index node displayed by area B corresponds to the index node displayed by area B of FIG. 2. Area A1 of FIG. 3 displays the search mode corresponding to the next-level index corresponding to the index node displayed by area B. Areas B1, C1, D1, E1, and F1 display the information record index relating to the search mode. For example, area A1 displays location search mode, area B displays location A, and areas B1, C1, D1, E1, and F1 display various messages from people in location A.

Referring back to FIGS. 1A and 1B, in 200, the touchscreen terminal opens and displays the information record corresponding to the index node.

Based on above operation 180, in the event that the index node does not have a next-level index and a user-input touch action is received and determined as an index search action, the touchscreen terminal opens and displays the information record corresponding to the index node.

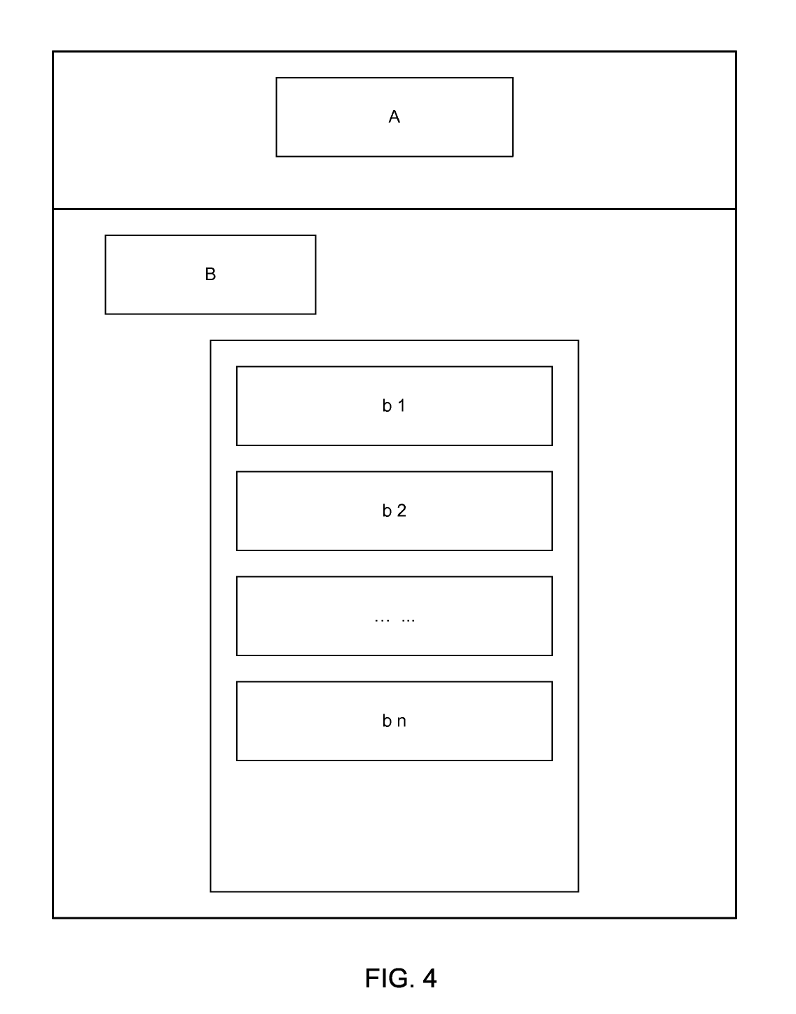

FIG. 4 is an information records diagram of an embodiment of a process for searching information records.

In some embodiments, assume that the touchscreen display zone corresponding to the index node displayed by area B1 of FIG. 3 detects and receives a search start action. The touchscreen terminal then opens and displays the information record as shown in FIG. 4. Area A displays the search mode when opening and displaying the current information record. Areas b1, b2 . . . bn display all of the information records corresponding to the index node displayed by area B.

Referring back to FIGS. 1A and 1B, in 210, the touchscreen terminal determines whether index nodes included in the next-level index corresponding to the index node exceed one screen.

Based on the above operation 190, in the event that the index nodes included in the next-level index are relatively numerous and the displayed index nodes cover the entire display area of the touchscreen when content currently displayed by the touchscreen includes the next-level index, a determination is made regarding the index nodes of the next-level index. In other words, the index nodes of the next-level index are analyzed to determine whether content exists outside of the touchscreen display area. In the event that content exists outside of the touchscreen display area, operation 230 is performed.

In 220, the touchscreen terminal determines whether records included in the information records exceed one screen.

Based on above operation 190, in the event that the records included in the information records are relatively numerous and the displayed information records cover the entire display area of the touchscreen when the content currently displayed by the touchscreen is the information records corresponding to the index node, a determination is to be made regarding the information records corresponding to the index nodes. In other words, the information records corresponding to the index nodes are analyzed to determine whether content exists outside of the touchscreen display area. If content exists outside of the touchscreen display area, operation 230 is performed.

In 230, the touchscreen terminal receives a predetermined touch action and provides a scrolling display.

Based on the above operation 140, a response is made to the determination that the index nodes corresponding to the index have content outside of the touchscreen display area; based on the above operation 210, a response is made to the determination that the next-level index corresponding to the index node has content outside of the touchscreen display area; and based on the above operation 220, a response is made to the determination that the information records corresponding to the index node have content outside of the touchscreen display area.

In operation 230, the touchscreen detects and receives a user-input screen sliding action and responds to the three situations described above (operations 140, 210, and 220). As a result, the index nodes corresponding to the index, the next-level index corresponding to the index node, and the information records corresponding to the index node can be scroll-displayed on the touchscreen.

The screen sliding action includes an upward sliding action or a downward sliding action. The upward sliding action corresponds to a single-finger upward-directed sliding touch action. The downward sliding action corresponds to a single-finger downward-directed sliding touch action. Moreover, the upward sliding action corresponds to upward scrolling display of content displays on the touchscreen.

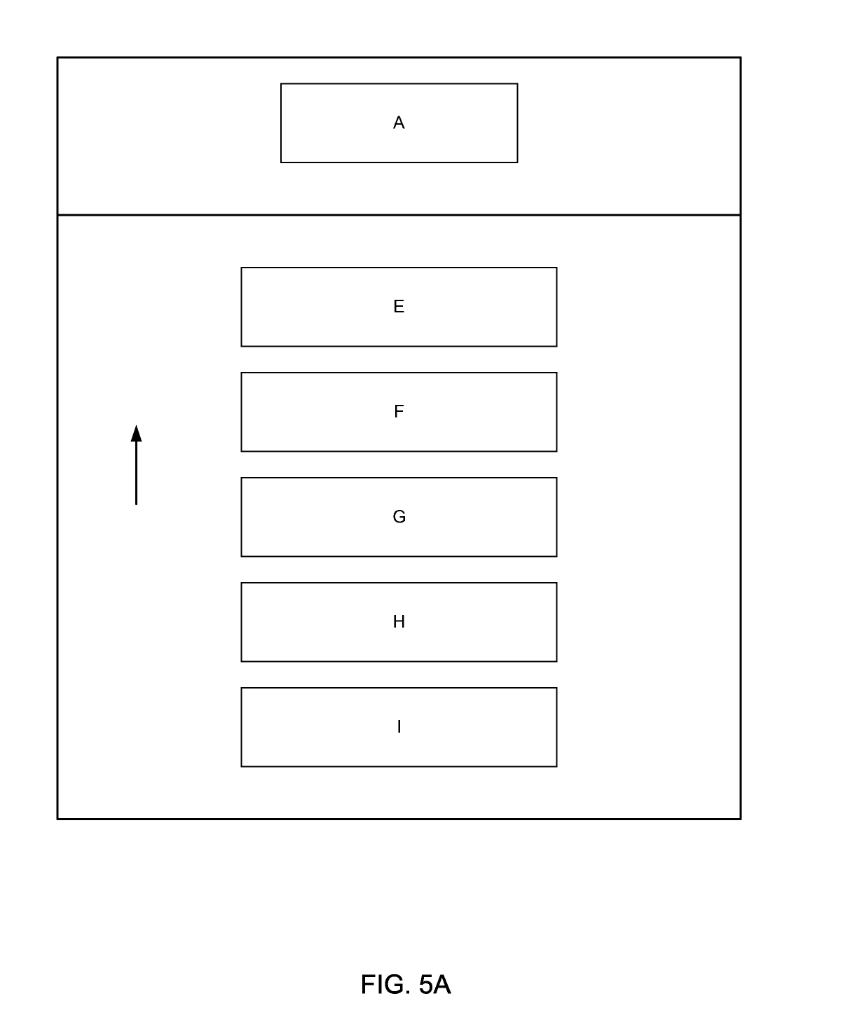

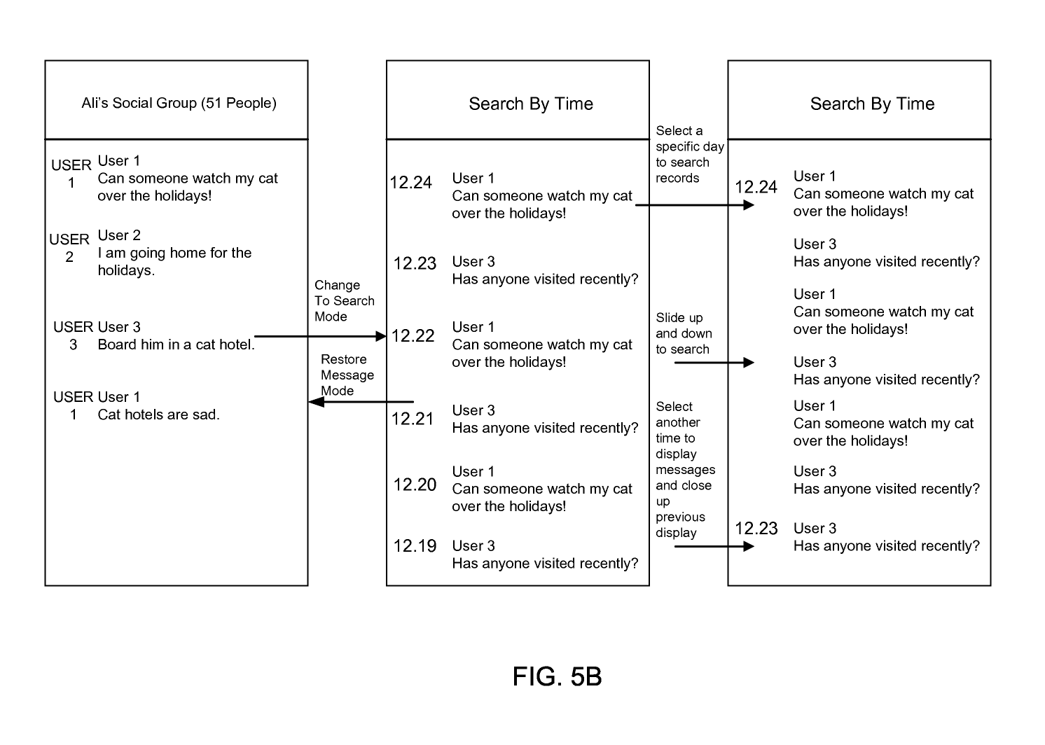

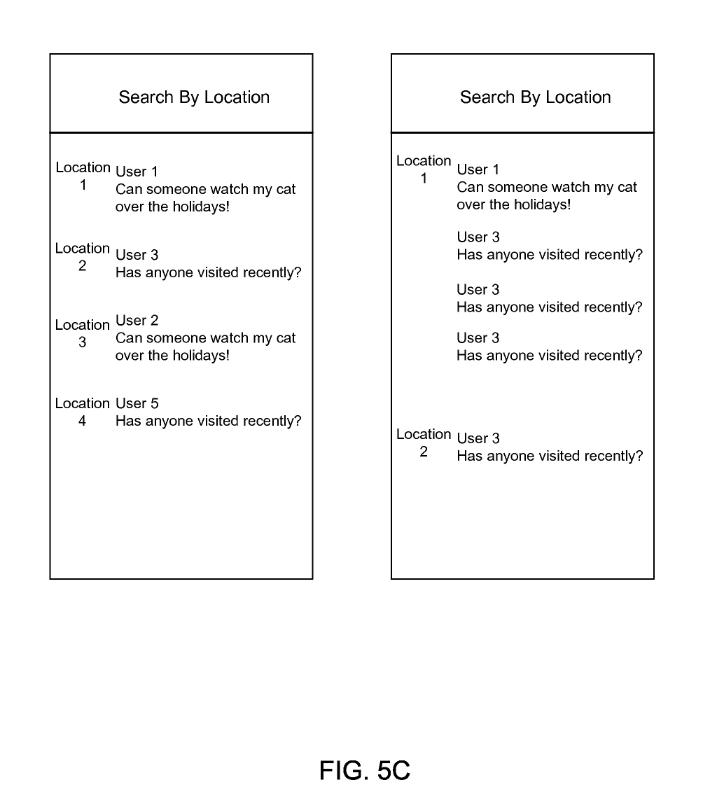

FIG. 5A is a scrolling display diagram of an embodiment of a process for searching information records.

When comparing FIGS. 2 and 5A, FIG. 5A shows index nodes corresponding to an index displayed by the touchscreen terminal after the touchscreen is slid upward based on an upward sliding action performed by the user, and FIG. 2 shows index nodes corresponding to the index displayed by the touchscreen. The downward sliding action is similar to the upward sliding action. In addition, the next-level index corresponding to the index node and the information records corresponding to the index node are similar to the index nodes corresponding to the index in the manner based on which screen sliding actions issued by the user are implemented. In addition, other touch actions can be employed to implement the above screen sliding actions.

In 240, the touchscreen terminal determines whether the touch action corresponds to a search exiting action.

Based on the above operation 230, after the application program is switched to a search mode, the user locates target records or does not locate target records. A search exiting action is performed based on the user's need. In the event that the touchscreen terminal detects and receives a search exiting action input by the user, the touchscreen terminal exits the search mode. Similarly, after the above operations 140, 160, 190, 200, and 230 are completed, the user can exit from the current search mode based on the search exiting action.

In some embodiments, the search exiting action corresponds to a double-finger leftward-sliding touch action. Furthermore, other touch actions can be used as the search exiting action.

In 250, the touchscreen terminal instructs the application program to exit the search mode and returns to the interface prior to entering the search mode.

Based on the above operation 240, after the touchscreen terminal responds to the search exiting action, the touchscreen terminal instructs the application program to return to the interface prior to entering the search mode.

FIG. 5B is diagrams of an example of a time search of information records. One diagram shows that the search mode can be initiated from a message mode. The next diagram shows the selection of a specific day to search records, the selection of another time to display a message, and that the message mode can be restored. Another diagram displays records from the selected time, which can be slid up and down.

FIG. 5C is diagrams of examples of location searches of information records. In one diagram, a location is used to search records. In another diagram, another location is used to search records.

FIG. 6 is a diagram of an embodiment of a device for searching information records. In some embodiments, the touchscreen terminal or device 300 implements the process 100 of FIGS. 1A and 1B and comprises: a touch action detecting and receiving unit 310, a search mode switching unit 320, an index displaying unit 340, an information search determining unit 350, and an index node opening and displaying unit 360.

In some embodiments, the touch action detecting and receiving unit 310 detects and receives a touch action input by a user via a touchscreen.

In some embodiments, the search mode switching unit 320 determines whether the touch action corresponds to a predefined search switching action, and in the event that the touch action corresponds to a search switching action, switches the application program currently displayed on the touchscreen to a search mode corresponding to the search switching action.

In some embodiments, the index displaying unit 340 displays on the touchscreen an information record index under the search mode for the application program.

In some embodiments, the information search determining unit 350 determines whether a touchscreen display zone corresponding to an index node in the information record index displayed by the touchscreen has detected an information search action input by the user.

In some embodiments, the index node opening and displaying unit 360 opens and displays an information record or a next-level index corresponding to the index node in the event that the information search action input by the user is detected.

In some embodiments, the device 300 further includes a mode switching unit 330.

In some embodiments, in the event that the mode switching unit 330 detects and receives a mode switching action input by the user via the touchscreen, the mode switching unit 330 switches the mode of the application program among multiple search modes based on the mode switching action.

In some embodiments, the device 300 further comprises a search exiting unit 370.

In some embodiments, in the event that the search exiting unit 370 detects and receives a search exiting action input by the user via the touchscreen, the search exiting unit 370 instructs the application program to exit the search mode and return to the interface prior to the search mode in the event that the touchscreen terminal is already in a search mode.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

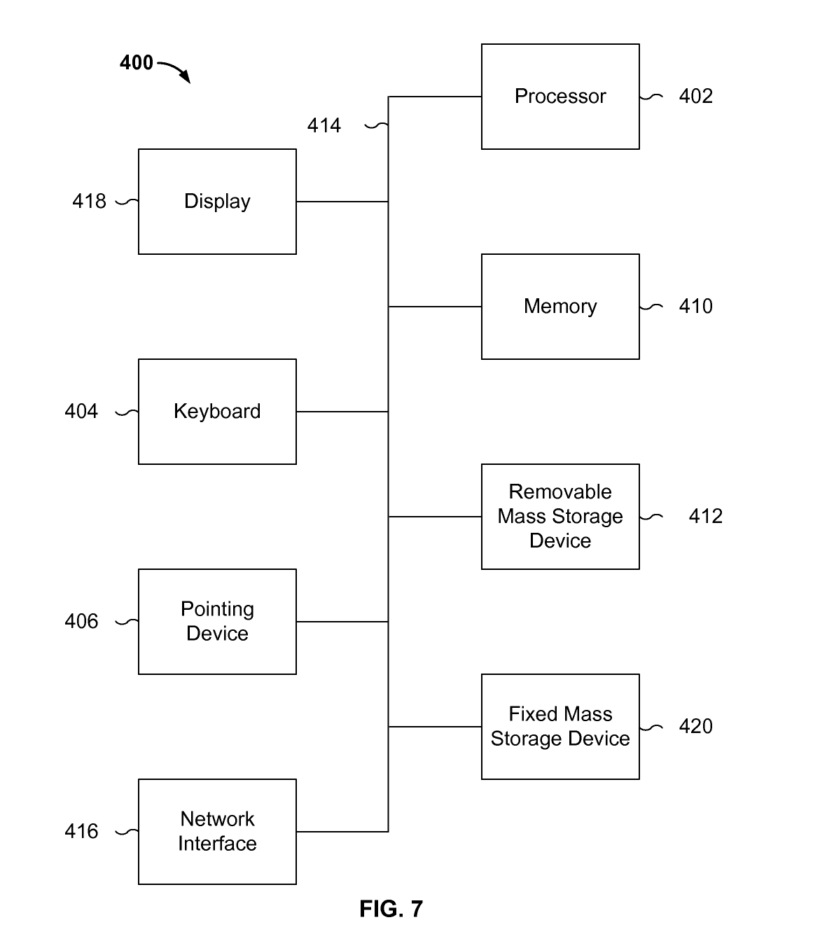

FIG. 7 is a functional diagram illustrating an embodiment of a programmed computer system for searching information records. As will be apparent, other computer system architectures and configurations can be used to search information records. Computer system 400, which includes various subsystems as described below, includes at least one microprocessor subsystem (also referred to as a processor or a central processing unit (CPU)) 402. For example, processor 402 can be implemented by a single-chip processor or by multiple processors. In some embodiments, processor 402 is a general purpose digital processor that controls the operation of the computer system 400. Using instructions retrieved from memory 410, the processor 402 controls the reception and manipulation of input data, and the output and display of data on output devices (e.g., display 418).

Processor 402 is coupled bi-directionally with memory 410, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 402. Also as is well known in the art, primary storage typically includes basic operating instructions, program code, data, and objects used by the processor 402 to perform its functions (e.g., programmed instructions). For example, memory 410 can include any suitable computer-readable storage media, described below, depending on whether, for example, data access needs to be bi-directional or uni-directional. For example, processor 402 can also directly and very rapidly retrieve and store frequently needed data in a cache memory (not shown).

A removable mass storage device 412 provides additional data storage capacity for the computer system 400, and is coupled either bi-directionally (read/write) or uni-directionally (read only) to processor 402. For example, storage 412 can also include computer-readable media such as magnetic tape, flash memory, PC-CARDS, portable mass storage devices, holographic storage devices, and other storage devices. A fixed mass storage 420 can also, for example, provide additional data storage capacity. The most common example of mass storage 420 is a hard disk drive. Mass storages 412, 420 generally store additional programming instructions, data, and the like that typically are not in active use by the processor 402. It will be appreciated that the information retained within mass storages 412 and 420 can be incorporated, if needed, in standard fashion as part of memory 410 (e.g., RAM) as virtual memory.

In addition to providing processor 402 access to storage subsystems, bus 414 can also be used to provide access to other subsystems and devices. As shown, these can include a display monitor 418, a network interface 416, a keyboard 404, and a pointing device 406, as well as an auxiliary input/output device interface, a sound card, speakers, and other subsystems as needed. For example, the pointing device 406 can be a mouse, stylus, track ball, or tablet, and is useful for interacting with a graphical user interface.

The network interface 416 allows processor 402 to be coupled to another computer, computer network, or telecommunications network using a network connection as shown. For example, through the network interface 416, the processor 402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 402 can be used to connect the computer system 400 to an external network and transfer data according to standard protocols. For example, various process embodiments disclosed herein can be executed on processor 402, or can be performed across a network such as the Internet, intranet networks, or local area networks, in conjunction with a remote processor that shares a portion of the processing. Additional mass storage devices (not shown) can also be connected to processor 402 through network interface 416.

An auxiliary I/O device interface (not shown) can be used in conjunction with computer system 400. The auxiliary I/O device interface can include general and customized interfaces that allow the processor 402 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 7 is but an example of a computer system suitable for use with the various embodiments disclosed herein. Other computer systems suitable for such use can include additional or fewer subsystems. In addition, bus 414 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
detecting a touch action input by a user via a touchscreen;
determining whether the touch action corresponds to a predefined search switching action;
in the event that the touch action corresponds to the predefined search switching action, switching an application program currently displayed on the touchscreen to a search mode corresponding to the search switching action;
displaying on the touchscreen an information record index relating to the search mode for the application program;
determining whether a touchscreen display zone corresponding to an index node in the information record index displayed by the touchscreen has detected an information search action input by the user; and
displaying an information record or a next-level index corresponding to the index node in the event that the information search action input by the user has been detected.

2. The method as described in claim 1, wherein the search switching action includes a time search switching action, a contact search switching action, a location search switching action, or any combination thereof.

3. The method as described in claim 2, wherein:
the search mode includes a time search mode, a contact search mode, a location search mode, or any combination thereof;
the time search switching action corresponds to the time search mode;
the contact search switching action corresponds to the contact search mode;
the location search switching action corresponds to the location search mode;
the information record index for the application program under the time search mode is a time index;
the information record index for the application program under the contact search mode is a contact index; and
the information record index for the application program under the location search mode is a location index.

4. The method as described in claim 3, wherein the next-level index corresponding to the index node corresponds to the time index, the contact index, the location index, or any combination thereof.

5. The method as described in claim 4, wherein the displaying of the information record or the next-level index corresponding to the index node in the event that the information search action input by the user is detected comprises:
determining whether the index node has a corresponding next-level index;
in the event that the index node has a corresponding next-level index, displaying the next-level index corresponding to the index node; and
in the event that the index node does not have a corresponding next-level index, opening the information record corresponding to the index node and displaying the opened information record on the touchscreen.

6. The method as described in claim 5, further comprising:
after the opening the information record corresponding to the index node and the is displaying of the opened information record on the touchscreen:
determining whether records contained in the information record exceed one screen; and
in the event that records contained in the information record exceed one screen, receiving a predetermined touch action, the information record being displayed on a scrolling display on the touchscreen.

7. The method as described in claim 1, wherein:
the search switching action comprises a default search switching action; and
the default search switching action corresponds to the time search mode, the contact search mode, or the location search mode.

8. The method as described in claim 1, wherein the touch action includes a mode switching action; and
further comprising:
determining whether the mode switching action is input by the user via the touchscreen; and
in the event that the mode switching action is input by the user via the touchscreen, switching a mode of the application program among multiple search modes based on the mode switching action.

9. The method as described in claim 1, wherein the touch action includes a search exiting action; and
further comprising:
determining whether a mode is already in a search mode and the search exiting action input by the user via the touchscreen is received; and
in the event that the mode is already in the search mode and the search exiting action input by the user via the touchscreen is received, exiting the search mode of the application program and returning to an interface prior to the search mode.

10. The method as described in claim 1, wherein the touch action includes a tap action, a sliding action, a sensing action, or any combination thereof.

11. The method as described in claim 1, further comprising:
after displaying index nodes corresponding to the information record index on the touchscreen:
determining whether the index nodes included in the index exceed one screen; and
in the event that the index nodes included in the index exceed one screen, receiving a predetermined touch action, the index being displayed on a scrolling display on the touchscreen.

12. The method as described in claim 3, wherein:
time index nodes in the time index are arranged in chronological order;
contact index nodes in the contact index are arranged in alphabetical order of contact surnames; and
location index nodes in the location index are arranged in order of location information names.

13. A device, comprising:
a touch action detecting and receiving unit configured to: detect a touch action input by a user via a touchscreen;
a search mode switching unit configured to:
determine whether the touch action corresponds to a predefined search switching action; and
in the event that the touch action corresponds to the predefined search switching action, switch an application program currently displayed on the touchscreen to a search mode corresponding to the search switching action;
an index displaying unit configured to: display on the touchscreen an information record index relating to the search mode for the application program;
an information search assessing unit configured to: determine whether a touchscreen display zone corresponding to an index node in the information record index displayed by the touchscreen has detected an information search action input by the user; and
an index node opening and displaying unit configured to: display an information record or a next-level index corresponding to the index node in the event that the information search action input by the user has been detected.

14. The device as described in claim 13, further comprising:
a mode switching unit configured to: switch a mode of the application program among multiple search modes based on a mode switching action upon detecting a mode switching action input by the user via the touchscreen.

15. The device as described in claim 13, further comprising:
a search exiting unit configured to: in the event that the touchscreen terminal is already in a search mode, exit the search mode of the application program and return to an interface prior to the search mode upon detecting a search exiting action input by the user via the touchscreen.

16. The device as described in claim 13, wherein the search switching action includes a time search switching action, a contact search switching action, a location search switching action, or any combination thereof.

17. The device as described in claim 16, wherein:
the search mode includes a time search mode, a contact search mode, a location search mode, or any combination thereof;
the time search switching action corresponds to the time search mode;
the contact search switching action corresponds to the contact search mode;
the location search switching action corresponds to the location search mode;
the information record index for the application program under the time search mode is a time index;
the information record index for the application program under the contact search mode is a contact index; and
the information record index for the application program under the location search mode is a location index.

18. The device as described in claim 17, wherein the next-level index corresponding to the index node corresponds to the time index, the contact index, the location index, or any combination thereof.

19. A computer program product being embodied in a tangible non-transitory computer readable storage medium and comprising computer instructions for:
detecting a touch action input by a user via a touchscreen;
determining whether the touch action corresponds to a predefined search switching action;
in the event that the touch action corresponds to the predefined search switching action, switching an application program currently displayed on the touchscreen to a search mode corresponding to the search switching action;
displaying on the touchscreen an information record index relating to the search mode for the application program;
determining whether a touchscreen display zone corresponding to an index node in the information record index displayed by the touchscreen has detected an information search action input by the user; and
displaying an information record or a next-level index corresponding to the index node in the event that the information search action input by the user has been detected.
